(19) United States
(12) Patent Application Publication
(10) Pub. No.: US 2024/0330778 A1
(43) Pub. Date: Oct. 3, 2024

(54) BOREHOLE HOLDUP PREDICTION USING MACHINE LEARNING AND PULSED NEUTRON LOGGING TOOL DATA

(71) Applicant: Halliburton Energy Services, Inc., Houston, TX (US)

(72) Inventors: Yogendra Singh, Bangalore (IN); Mayir Mamtimin, Houston, TX (US); Fahad Ahmad, Houston, TX (US)

(21) Appl. No.: 18/194,887

(22) Filed: Apr. 3, 2023

(51) Int. Cl. G06N 20/20

(52) U.S. Cl. CPC G06N 20/20

(57) ABSTRACT

In some implementations, a method for controlling a learning machine to predict fluid holdup in a borehole comprises generating an expanded dataset of simulated pulsed neutron logging (PNL) data based, at least in part, on an original dataset of empirical PNL data, converting, using one or more calibration coefficients, the simulated PNL data into lab-equivalent synthetic data, and training an ensemble of machine learning models based on the lab-equivalent synthetic data.

### TECHNICAL FIELD

The disclosure generally relates to pulsed logging operations involving conveying a logging tool into a borehole extending through one or more subsurface formations, and in particular, learning machines used to optimize borehole holdup predictions from collected and simulated logging data.

### BACKGROUND

Holdup refers to the volumetric ratios of oil, water, and gas in a borehole. Accurately determining values of holdup may be necessary for saturation corrections and fluid profiling. Traditionally, holdup is determined through data collection using a pulsed neutron logging (PNL) tool and rule-based calculations applied to the PNL data.

### BRIEF DESCRIPTION OF THE DRAWINGS

Implementations of the disclosure may be better understood by referencing the accompanying drawings.

FIG. 1 is an example block diagram depicting operations for borehole holdup prediction via a machine learning approach, according to some implementations.

FIG. 2 is a flowchart depicting a different perspective on training and deploying a learning machine, according to some implementations.

FIG. 3 is a diagram depicting a pair of example calibration curves, according to some implementations.

FIG. 4 is a schematic diagram depicting training data preparation, according to some implementations.

FIG. 5 is a conceptual diagram depicting an example system comprising a holdup prediction system, according to some implementations.

FIG. 6 is a flowchart describing a method for generating a dataset of lab-equivalent simulation data and validating the dataset against real-world lab data, according to some implementations.

FIG. 7 is a cross-sectional diagram depicting an example well system, according to some implementations.

### DESCRIPTION

### Overview

Determining a borehole's fluid holdup may be useful in fluid profiling and saturation corrections. Holdup, referring to fractions of oil, gas, and water volumes present in an interval of pipe in a borehole, may offer insight into a flow profile of fluids in the borehole. Traditional methods for determining the holdup may use data obtained from a PNL tool and apply one or more rule-based calculations to predict the holdup. This approach may result in low-accuracy results. To obtain higher accuracy results, a machine learning approach is utilized. The PNL tool produces bursts of high-energy neutrons that may be detected by two detectors-a near detector and a far detector. When neutrons emitted from a neutron generator on the PNL tool interact with atomic nuclei of elements present in the borehole region and subsurface formation, secondary radiation is produced. The secondary radiation may be detected by the far and near detectors. A learning machine may be configured to utilize an energy spectrum obtained via the detected secondary radiation to predict holdup in the borehole more accurately. Simulation data and lab data may be used in generating features for training the learning machine learning. Once the model is trained, it may be deployed to predict the holdup in real-world scenarios.

### Example Holdup Prediction Via Machine Learning Approach

Some implementations may utilize a system architecture to enable predictions of borehole holdup via a machine learning approach. Substantial historic data for borehole holdup prediction may not be readily available, and the described approach relates to synthesizing training data to feed into an ML model using lab data and simulated PNL data. The training data may be used to train a learning machine to implement the ML model. In this disclosure, the terms learning machine and ML model may be used interchangeably as both learning machines and ML models may include components such as processors, memory, computer-executable instructions and/or other logic for implementing machine learning methodologies described herein. In some implementations, a single learning machine may include a plurality of different ML models, where the learning machine may select between the different ML models. In such implementations, each different ML model may include computer-executable instructions for performing a different method of machine learning.

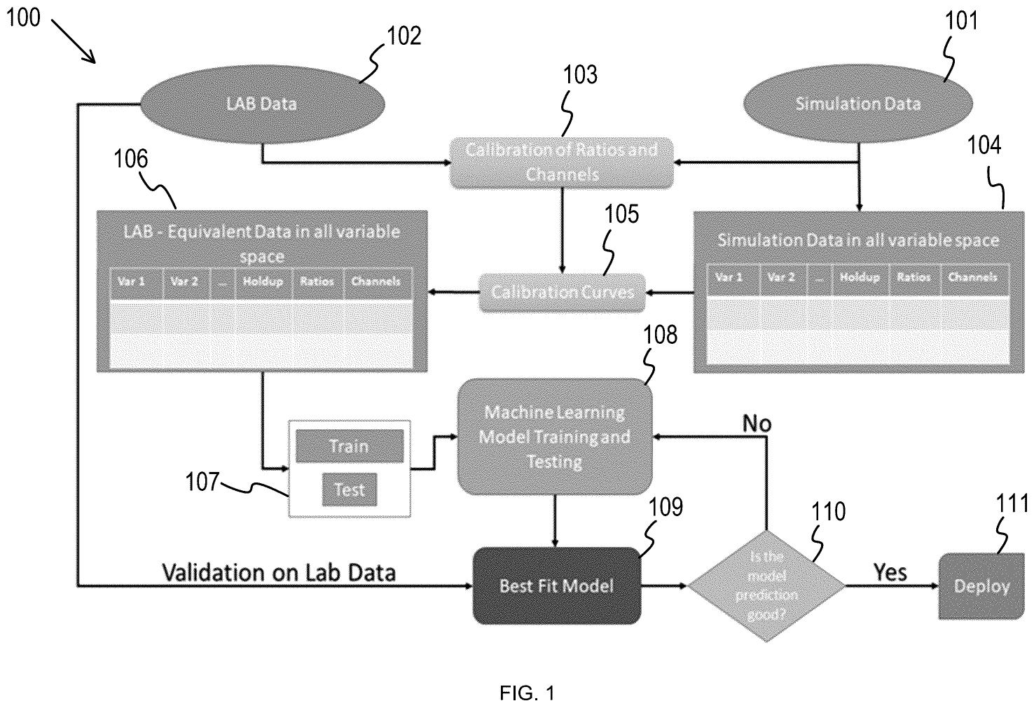

FIG. 1 is an example block diagram depicting operations for borehole holdup prediction via a machine learning approach, according to some implementations. A sequence of operations in the block diagram 100 may comprise generating training data to feed into an ML model, training the ML model, and deploying the ML model to predict borehole holdup in real-world scenarios. Flow of the block diagram 100 begins at block 101.

At block 101, simulated PNL data is generated and then extracted from one or more simulations files. Simulation data may be generated through combinations of real-world data comprising measurements obtained via a PNL tool and lab data created through experimentation. For example, a Monte Carlo N-Particle simulator or a similar algorithm may be used to generate simulated PNL spectrums. Each simulated PNL spectrum may comprise a plurality of channels of varying energy levels. In some implementations, each simulated PNL spectrum may comprise up to 256 channels. Because it may be difficult to conduct thousands of experiments to create a substantial dataset of lab data for accurate modeling, using simulated data may allow for an expanded variable space. Some of the channels may heavily impact borehole holdup or may comprise variables that heavily influence values of borehole holdup—these channels and parameters may be selected as features for the ML model. For example, of the potential 256 channels, portions or a compression of the PNL spectrum comprising 10-20 channels may be extracted for training dataset generation.

In some implementations, the simulated PNL data may include various ratios in relation to borehole holdup. For example, an example borehole or wellbore may comprise water, oil, and gas. The ratios may, in some implementations, comprise volumetric ratios between the fluids in the borehole. Near and far detectors (positioned near a neutron source of a PNL tool and farther from a neutron source of the PNL tool, respectively) may be configured to detect gamma rays emitted from molecules within an example formation. Measurements correlating to carbon signatures may indicate a presence of hydrocarbons (oil, gas). Oxygen signatures of a higher count rate than carbon signatures may indicate a presence of water. Low density measurements may indicate a presence of a vapor/gas. These parameters may be included during feature generation for use in an ML training dataset.

In some implementations, the simulated PNL data may include various ratios relating to other parameters in the borehole. The above carbon, oxygen, and density signatures may be correlated via one or more ratios indicative of the environment in the borehole. For example, a carbon-to-oxygen ratio may be indicative of hydrocarbons in the subsurface, and a near-to-far ratio may be used to normalize fluid and gas measurements in the borehole. Flow progresses to block 102.

At block 102, lab data generated via one or more experiments is obtained. The lab data may be obtained concurrently with the simulation data at block 101. In some implementations, both the simulation data and the lab data may be obtained based on the same environmental parameters. For example, the lab data may comprise a certain borehole size, a formation type, and other environmental parameters that the simulation data may be modeled after. Flow progresses to block 103.

At block 103, the ratios and channels within the simulated PNL data (see block 101) may be calibrated. Physical parameters, ratios, and channels within simulated PNL data may be calibrated to mimic or closely match those in the real-world lab data. By mimicking the behavior of lab data, the simulated PNL data may more closely match the lab data. Any remaining discrepancies between the simulated PNL data and the lab data may be revealed via calibration curves created (later) at block 105. Flow progresses to block 104.

At block 104, the calibrated, simulated PNL data is input into a simulation data table. The simulation data table may comprise a plurality of rows, where each row contains a plurality of physical parameters (Var 1, Var 2, etc.). The simulation table may comprise a borehole holdup value for each row, as well as various ratios and the energy channel to which the data belongs. The simulation data table also may include physical parameters comprising simulation conditions. The use of simulated PNL data in the simulation data table may allow for an expanded variable set that lab data alone may not encompass. Flow progresses to block 105.

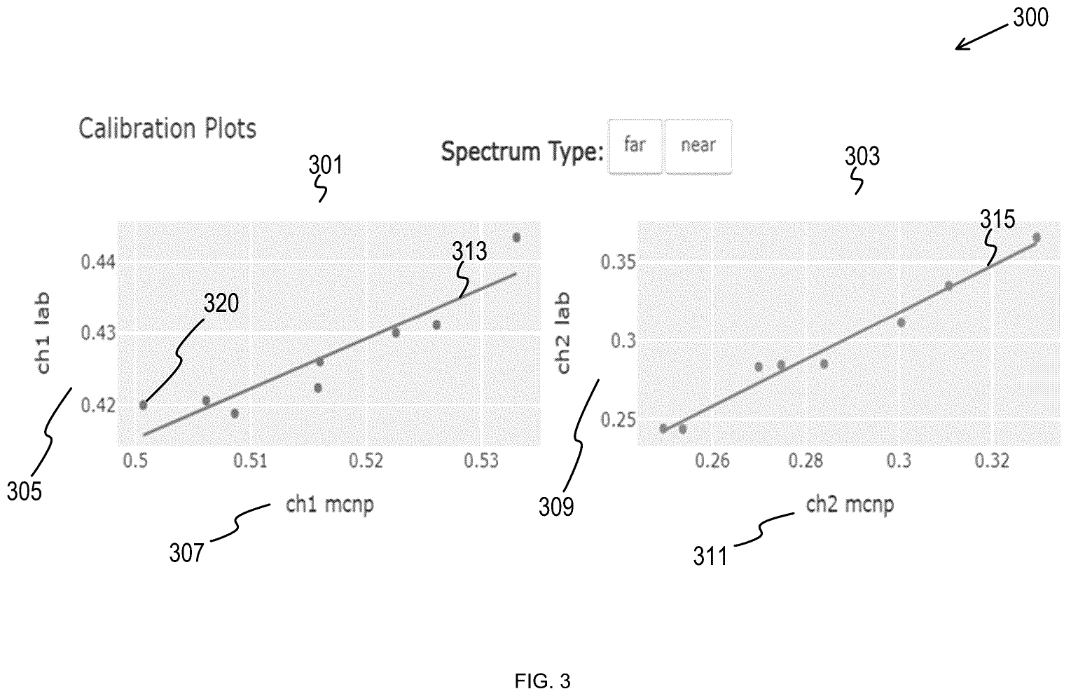

At block 105, calibration curves are generated based on the simulation data table comprising the simulated PNL data. The calibration curves may allow for data visualization between the lab data of block 102 and the simulated, calibrated PNL data within the simulation data table at block 104. The calibration curves may be generated using a best-fit line approach. The calibration curves may be used to determine one or more calibration coefficients based on curve equation of best fit. The calibration coefficients may be used to convert simulated data into lab-equivalent data. These calibration curves are described with additional detail in the description of FIG. 3. Flow progresses to block 106.

At block 106, the one or more calibration functions of block 105 may be used to convert the simulated PNL data of block 104 into lab-equivalent synthetic data, but with an expanded variable set which may not be feasible with the real-world lab data set of block 102. In essence, the calibrated, simulated PNL data of block 104 is mapped to corresponding lab-data equivalent values via the calibration coefficients and input into a lab-equivalent synthetic data table. The lab-equivalent synthetic dataset may comprise one or more categorical features such as the type of borehole configuration in which the simulation was performed. For example, the borehole configuration may be categorized as a completion type (either open hole or cemented and cased) or a production type (open hole with production tubing or cased hole with production tubing). A formation composition may also be considered a categorical feature. In some implementations, the formation composition may be selected as either limestone, dolomite, anhydrite, sandstone, etc. The one or more categorical features may be converted into numerical features and input into the lab-equivalent synthetic data table. In some implementations, the categorical features are converted to numerical features via one-hot encoding. Once all simulated PNL data has been converted into lab-equivalent synthetic data values, the resulting dataset may be used to train and test one or more ML models. Flow progresses to block 107.

At block 107, the lab-equivalent simulated PNL dataset output from block 106 may be split into a training dataset and a testing dataset. In some implementations, final feature selection may occur before splitting the lab-equivalent data. In some implementations, the lab-equivalent data may be divided along a 70/30 or 80/20 split (i.e., 70% of the data may be used for training a model, 30% may be used for testing the model). Flow progresses to block 108.

At block 108, one or more ML models may be trained and tested. For example, an ensemble of pre-selected ML models may be built into a learning machine. In some implementations, the ML models may comprise linear models, non-linear models, regression models, classification models, decision trees, deep-learning models, neural networks, and any other suitable model for machine learning. For example, one or more regression models may be used on the lab-equivalent synthetic dataset for training an ML model. The ML model may then be tested on the testing dataset. Flow progresses to block 109.

At block 109, an ML model of best fit may be determined. In some implementations, the best fit ML model may be determined based on mean absolute error, mean squared error, r² score, and other error distribution analyses. For example, error distribution plots may be used to determine whether error is present in predictions of holdup made by the ML model. In some implementations, the best fit ML model may be determined based on one or more of the above-noted error distribution analyses. In some implementations, the ML models may range from biased models to overfitting models after testing. Flow progresses to block 110.

At block 110, a determination is made about whether a borehole holdup prediction output by the ML model is acceptable. Once the best-fit ML model is selected, the selected ML model may be validated using the real-world lab data from block 102. In traditional ML training and testing scenarios, a percentage of lab data may be used for training and testing an ML model (e.g., 70% or 80%) while a remaining percentage is reserved for validating the model. However, at block 109, the best-fit ML model is trained and tested entirely on simulated data, while the lab data of block 102 is reserved for model validation. In some implementations, the ML model may be self-validating.

If the holdup prediction made by the selected model is within a tolerance threshold of the lab data, the prediction may be considered acceptable. If the holdup prediction is outside the tolerance threshold, the learning machine may not move forward with the selected model. For example, if a model trained by the learning machine outputs results outside of a validation criteria (e.g., within 5% error of the lab data of block 102), the learning machine may abandon the model to train and test an alternative model within the ensemble. In other implementations, the learning machine may be configured to train and test a plurality of ML models, apply the validation criteria across the plurality of ML models, and filter out ML models that are beyond the validation criteria. The learning machine may then iterate through the remaining ML models and select the best fit model based on its accuracy with reference to the real-world lab data during validation. In other implementations, the learning machine may retrain one or more of the ML models if none of the ML models in the ensemble meet the validation criteria. Thus, flow progresses to block 111 if the selected ML model passes validation, and the selected ML model may be deployed to a real-world scenario. If the holdup prediction is sub-optimal, flow reverts back to block 108 where the ML model may undergo additional training and testing. Alternatively, the ML learning machine may abandon the ML model in favor of an alternative model. Flow progresses to block 111.

At block 111, the validated ML model may be deployed to a real-world scenario for predicting borehole holdup. For example, the validated ML model may be used to convert measured signals received by near and far detectors of a deployed PNL tool into values of borehole holdup. The holdup predictions may be output to a user interface at a job site or uploaded to a cloud server for remote viewing. Flow of the block diagram 100 ceases.

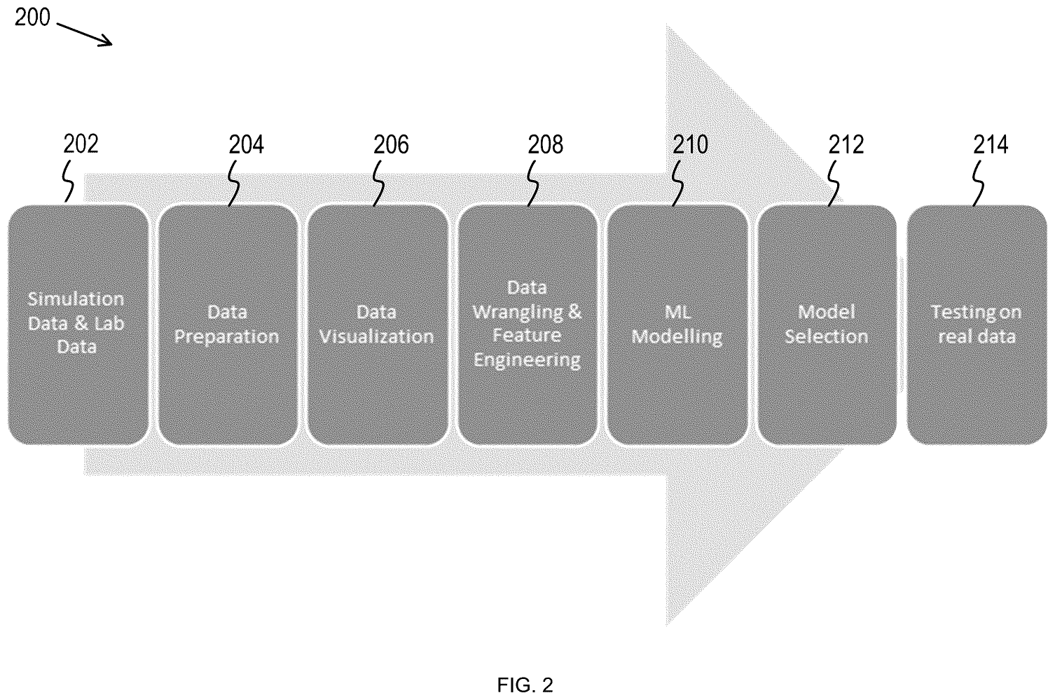

FIG. 2 is a flowchart depicting a different perspective on training and deploying a learning machine, according to some implementations. The operations depicted in a flowchart 200 may be described with reference to the operations of FIG. 1. Operations of the flowchart 200 begin at block 202.

At block 202, simulation data and lab data are generated and extracted. In some implementations, the simulation data, also referred to as synthetic data, may be generated in similar fashion to the simulation data of block 101. The simulation data may be generated using the same conditions as present in the lab data (same formation type, same borehole size, same mud type, same cement and casing specifications, etc.). The lab data may be generated through one or more experiments. The simulation data may be extracted from one or more simulation files, and both the simulation data and the lab data may be saved in the form of data tables. Flow progresses to block 204.

At block 204, the data is prepared for further processing. For example, this may include calibrating physical parameters, ratios, and/or channels from one or more portions of the simulated PNL spectrum to behave similarly to the physical parameters, ratios, and channels within the lab data. The calibrating may also correct deficiencies in the simulated PNL data prior to generating a final dataset used for model training. Flow progresses to block 206.

At block 206, data visualization measures are performed on the simulated data. For example, calibration curves may be created based on the simulated data and the lab data. In some implementations, the calibration curves may be similar to the calibration curves of block 105. The calibration curves may comprise a curve equation, and coefficients of the curve equation, which may be referred to as calibration coefficients, are used to convert simulated PNL data into lab-equivalent synthetic data. Flow progresses to block 208.

At block 208, data wrangling and feature engineering is performed. For example, the feature engineering may comprise reduction of the simulated PNL spectrum down to a few channels. Feature selection may involve using mathematical formulae to distill the channels down to constituent component that have considerable influence on values of borehole holdup (i.e., ratios between elements in the borehole, fluid densities, etc.). In some implementations, the features may be selected to include one or more ratios between various channels, features, or other components. For example, channels of the simulated PNL spectrum may be divided based on their energy levels and ranked from low energy to high energy signals. High energy channels may include a substantial amount of scattering, whereas lower energy channels may include little scattering of received signals. Parsing and selecting channels based on their energy level may condense the number of ratios and channels used in feature set engineering even further.

In some implementations, feature set engineering may comprise a physics-based selection process to select features based on their relative effects on borehole holdup. For example, various physical properties of oil, water, and gas (viscosity, density, velocity, etc.) may be used to select and engineer features. Carbon and oxygen signatures detected by the near and far detectors may be used to differentiate between oil and water in the borehole. A density measurement of fluid in the borehole may, for example, correlate directly to gas holdup, as any fluids in a gaseous or vapor phase may have a density lower than that of liquid hydrocarbons or water. In some implementations, general feature selection algorithms may be used to generate a feature set that maximize correlations between carbon, oxygen, and density measurements to values of borehole holdup. In other implementations, the features may be selected via recursive features elimination.

Once a feature set is generated, each of the features comprising the simulated PNL data may be mapped to lab-equivalent synthetic data via one or more calibration coefficients. In some implementations, this mapping may be similar to the process described in block 106. Flow progresses to block 210.

At block 210, one or more ML models of an ensemble of pre-selected models may be trained and tested using the lab-equivalent synthetic dataset output from block 208. In some implementations, this may be similar to the ML training and testing described at block 108. The features selected above may comprise independent variables fed into the ML models, while borehole holdup may be a dependent variable that is predicted by the ML models during training. Flow progresses to block 212.

At block 212, an ML model from the ensemble may be selected. In some implementations, the ML model selection process may be similar to the process described at block 109. Flow progresses to block 214.

At block 214, the selected ML model may be tested on real data. For example, a selected ML model may be validated against real-world lab data, similar to the validation process described at block 110 of FIG. 1. If the selected ML model passes a validation criterion against the real-world lab data, the ML model may be deployed to real-world scenarios for estimating borehole holdup. Flow of the flowchart 200 ceases.

FIG. 3 depicts an illustration 300 of example calibration curves, according to some implementations. The illustration 300 is described with reference to FIG. 1. For example, calibration curves 313 and 315 may be similar to the calibration curves described in blocks 105-106 of FIG. 1. A first calibration plot 301 may include an X-axis 307 depicting simulated values for a first channel (ch1) of a simulated PNL spectrum generated via a Monte Carlo N-Particle simulation tool (MCNP). The MCNP tool is a nuclear simulation tool which may simulate radiation, transportation, environmental conditions, and received signals that a real PNL tool may be subject to. The first calibration plot 301 may also include a Y-axis 305 depicting lab data for a first channel (ch1) of lab measurements of a real-world PNL spectrum. Both axes 305 and 307 may be dimensionless, as the simulated PNL data and real-world (lab) measurements may comprise the same parameters of varying quantities. For example, each data point 320 may represent a value or parameter measured in both the simulated data and the lab data. A discrepancy between lab data and simulated data (i.e., differences between the value of a data point on the X-axis 307 versus the Y-axis 305) may exist, which implies that the simulation data may require further calibration to match the lab data. In some implementations, the simulation data is to serve as a digital twin of the lab data with an expanded variable space.

The calibration curve 313 may be a line of best fit through the data points 320 as determined via a curve fitting algorithm. A formula of the calibration curve 313 may comprise one or more calibration coefficients used to directly map the simulated PNL data to the lab data. In some implementations, the calibration curve 313 and corresponding calibration coefficients may be used for interpolation and extrapolation of the simulated PNL data. When the simulated PNL data is converted to lab-equivalent synthetic data via the calibration coefficients, some variables which may have been unknown or untested in the lab environment may be estimated in the lab-equivalent synthetic data.

A second calibration plot 303 may comprise an X-axis 311 and a Y-axis 309. The X-axis 311 may include simulated MCNP values for a second, higher energy channel (ch2) of the simulated PNL spectrum. The Y-axis 309 may comprise lab data for the second, higher energy channel. The calibration curve 315 may be similar to the calibration curve 313. Each channel may comprise a unique calibration curve, and each detector (near, far, etc.) may comprise its own channels. For example, a near detector may obtain a different PNL spectrum than a far detector because of 1) its distance to the neutron source on the PNL tool, and 2) its proximity to a different region of the borehole. This phenomenon may be present in both the lab and simulated PNL data. Thus, the near detector may comprise 10 selected channels (ch1, ch2 . . . ch10), and the far detector may also comprise a set of 10 channels—the channels may be in response to the same emissions from the neutron source, but the received signals and corresponding PNL spectrums may differ. In this example, a total of 20 unique calibration curves may be generated, and each calibration curve may be used to calibrate its corresponding channel's simulated PNL data to its lab-equivalent counterpart.

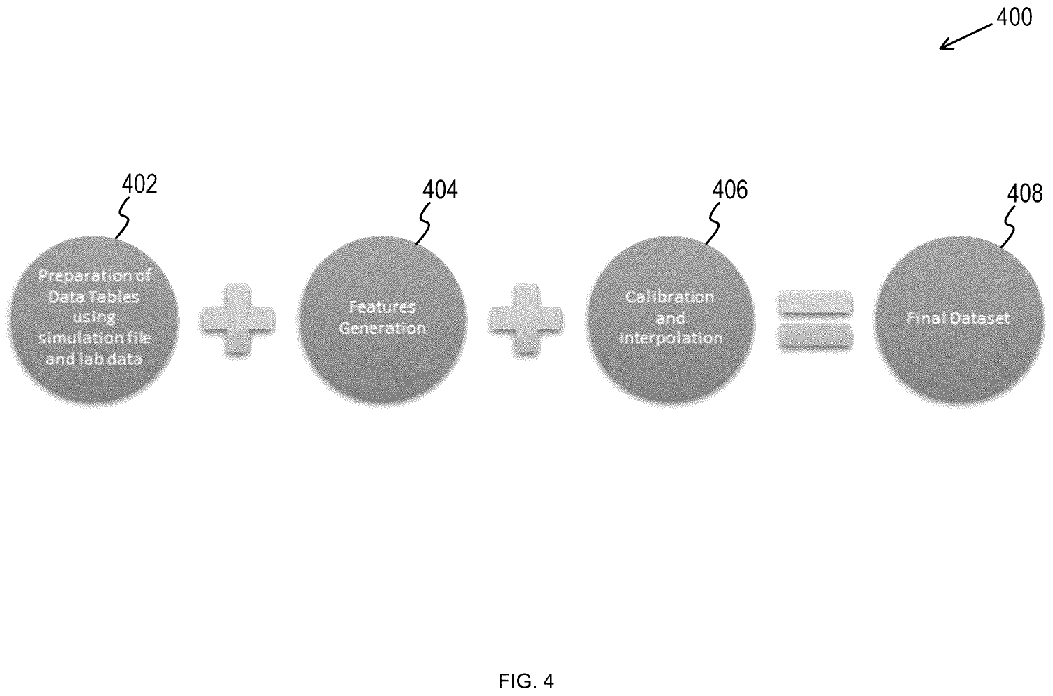

FIG. 4 is a schematic diagram depicting training data preparation, according to some implementations. A schematic diagram 400 depicts components and operations used to generate a final dataset to train one or more ML models. The schematic diagram 400 may be described with reference to FIG. 1 and FIG. 3.

At block 402, data tables are prepared using simulated PNL data extracted from an MCNP simulation file and lab data obtained via experimentation, respectively. For example, this data preparation process may be similar to the procedures described at blocks 101 and 102 of FIG. 1.

At block 404, a feature set may be generated from the simulated PNL data. For example, the feature set generation may be similar to the procedures described in at least blocks 106 and 208. The feature set may be undergo further processing prior to being output in a final training dataset.

At block 406, calibration and interpolation may be performed on the simulated PNL data to convert the simulated PNL data to lab-equivalent simulation data. For example, this calibration may be similar to the processes described at block 103 of FIG. 1. The simulated PNL data may also be interpolated based on calibration coefficients from a corresponding calibration curve equation. This calibration curve may be similar to either the calibration curve 313 or 315 of FIG. 3.

At block 408, a final training dataset is output. The final dataset may comprise simulated PNL data that has been mapped to real-world lab data via calibration coefficients. Each channel for both the near and far detectors may utilize a different calibration curve to perform the mapping. Once the entire simulation variable space is occupied by values corresponding to lab-equivalent data, the final dataset may be output for model training.

### Example Computer

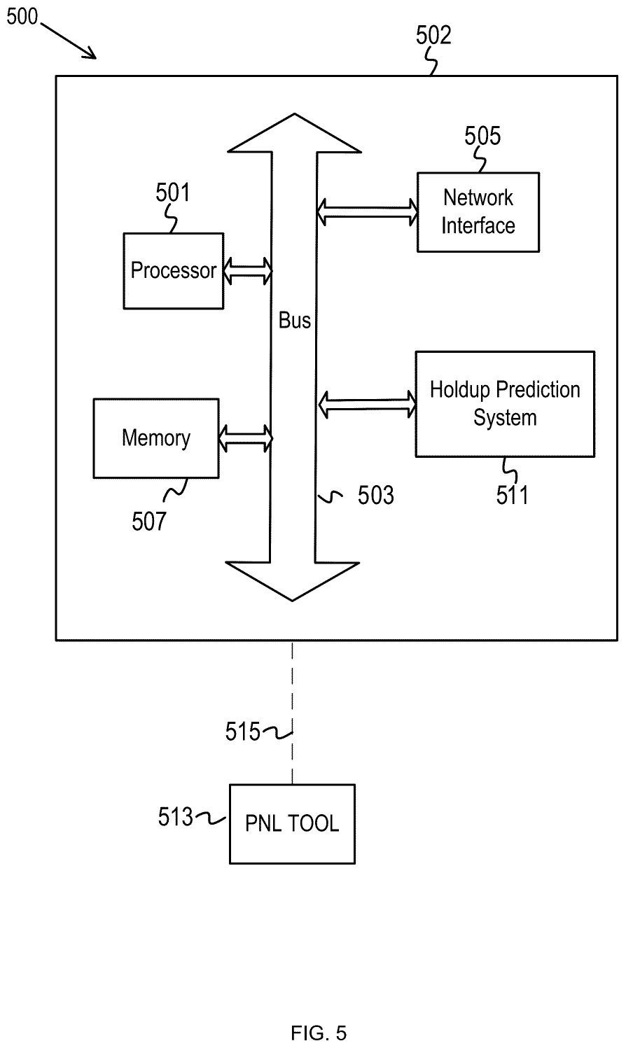

Implementations of the processes may be used in conjunction with an example system, as described in FIG. 5. FIG. 5 is a conceptual diagram depicting an example system comprising a holdup prediction system, according to some implementations. A system 500 is described with reference to FIGS. 1-4. A computer 502 may include a processor 501 (possibly including multiple processors, multiple cores, multiple nodes, and/or implementing multi-threading, etc.). The computer 502 includes a memory 507. The memory 507 may be system memory or any one or more of the above already described possible realizations of machine-readable media. The computer 502 also includes a bus 503 and a network interface 505. The computer 502 may communicate via transmissions to and/or from remote devices via the network interface 505 in accordance with a network protocol corresponding to the type of network interface, whether wired or wireless and depending upon the carrying medium. In addition, a communication or transmission may involve other layers of a communication protocol and or communication protocol suites (e.g., transmission control protocol, Internet Protocol, user datagram protocol, virtual private network protocols, etc.).

The computer 502 may also include a holdup prediction system 511. The holdup prediction system 511 may comprise a learning machine to perform the operations described in FIGS. 1-4. In some implementations, the holdup prediction system 511 may utilize cloud computing to allow for predictions of borehole holdup from a remote location. In other implementations, the holdup prediction system 511 may be physically located at a wellsite, possibly as an edge device.

The holdup prediction system 511 may perform one or more of the operations described herein. Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

The system 500 may also include a PNL tool 513. The PNL tool 513 may transmit neutron emissions into formations and capture sensor information indicating gamma radiation signatures in response to the emissions (see also the examples described with reference to FIGS. 1-4). The PNL tool 513 may provide sensor information used by the holdup prediction system 511 to determine holdup in a wellbore. For example, the PNL tool 513 may communicate sensor information to the holdup prediction system 511 via a communication link 515.

In some implementations, PNL sensor information and/or predicted holdup values may be used to perform one or more operations to measure or alter a fluid flow in a wellbore. For example, an operation may be initiated, modified, or stopped based on the predicted holdup values provided by the system 500. Examples of such operations may include determining an oil saturation of one or more subsurface formations via formation saturation analysis, determining a fluid or gas flow profile in the wellbore to determine production, opening or closing a choke to alter a flow rate of fluids to the surface, opening or shutting in flow via various subsurface formations, altering an artificial lift operation based on the holdup predictions, altering a tubing size used in the wellbore, etc. Accordingly, these operations may be adjusted to optimize a multi-phase flow profile of the well.

While the aspects of the disclosure are described with reference to various implementations and exploitations, it will be understood that these aspects are illustrative and that the scope of the claims is not limited to them. In general, techniques for borehole holdup predictions via a learning machine as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

### Example Method for Borehole Holdup Prediction

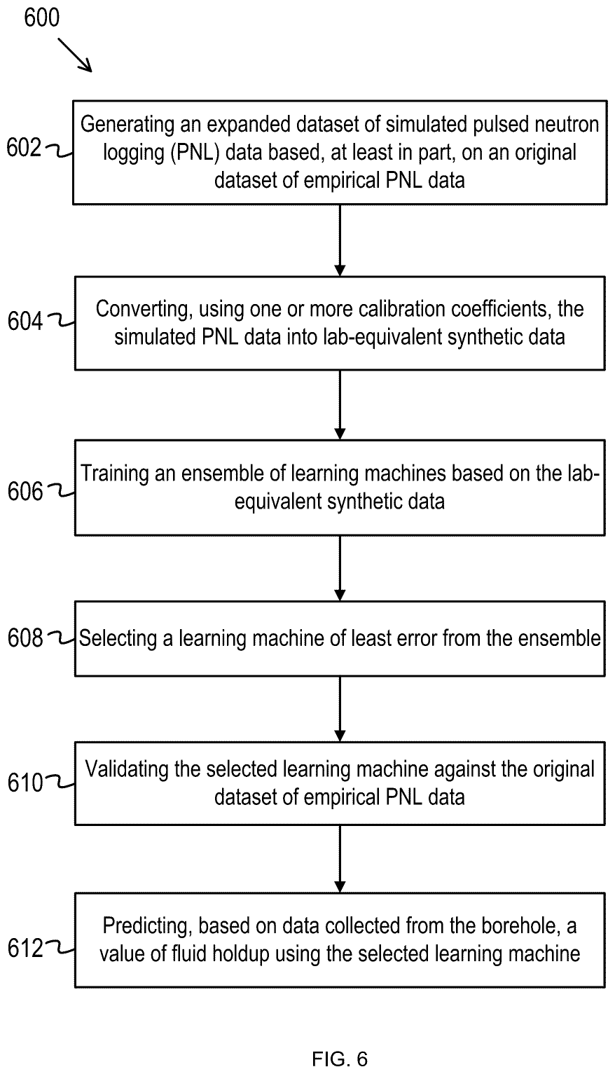

FIG. 6 is a flowchart 600 describing a method for generating a dataset of lab-equivalent simulation data and validating the dataset against real-world lab data, according to some implementations. With reference to FIG. 5, the method may be performed by the learning machine within the holdup prediction system 511. The flowchart 600 may include operations that bear resemblance to those described in FIGS. 1, 3, and 5. Operations of the flowchart 600 begin at block 602.

At block 602, the method may generate an expanded dataset of simulated pulsed neutron logging (PNL) data based, at least in part, on an original dataset of empirical PNL data. For example, the simulation data of block 101 may be generated by a Monte Carlo N-Particle simulation tool or similar software based on the original lab data of block 102. Flow progresses to block 604.

At block 604, the method may convert, using one or more calibration coefficients, the simulated PNL data into lab-equivalent synthetic data. For example, calibration coefficients one or more calibration curves may be used to convert the simulated PNL dataset of block 104 to the lab-equivalent synthetic data of block 106. In some implementations, the calibration curves may be similar to the calibration curves 313, 315 of FIG. 3. Various channels selected from a broader PNL spectrum may include one or more selected features based on their relative contributions to the borehole holdup. Each of the selected channels may include its own calibration curve used to calibrate a respective row of data in a simulation data table. The simulation data table may be similar to the data table described at block 104 comprising the simulated PNL data. Flow progresses to block 606.

At block 606, the method may train an ensemble of learning machines based on the lab-equivalent synthetic data. For example, the holdup prediction system 511 may train and test an ensemble of pre-selected ML models. The ML models may be selected based on their ability to consistently produce high-quality models. The ML models may be pre-loaded into the learning machine of the holdup prediction system 511, and the holdup prediction system 511 may train the ML models within the ensemble using the lab-equivalent synthetic data of block 106. Flow progresses to block 608.

At block 608, the method may select a learning machine of least error from the ensemble of ML models. For example, the holdup prediction system 511 may scan through results output from the ensemble of models and select a model from the ensemble based on a mean absolute error, mean squared error, r² score (coefficient of determination), other error distribution analyses, or a combination of multiple error analyses. Flow progresses to block 610.

At block 610, the method may validate the selected learning machine against the original dataset of empirical PNL data. For example, the selected learning machine may be fed values from the lab data of block 102. In the lab data, these values may correlate to a known value of borehole holdup which may be excluded from the variables fed into the selected learning machine. Using the input lab data, the selected learning machine may output a prediction of borehole holdup which may be compared to a true value of holdup in the lab data. The true value of borehole holdup was determined from the same variables fed into the model-thus, if the model prediction is not close to the true borehole holdup value, the model may not be deployed. However, if a predicted holdup value is within an error tolerance of the lab data, the selected model may be validated for that portion of the data. The selected learning machine may be validated across multiple channels of the PNL spectrum to ensure results are precise and accurate across a range of inputs. In some implementations, the holdup prediction system 511 may be configured to self-validate when selecting a final ML model to deploy. Flow progresses to block 612.

At block 612, the method may predict, based on data collected from the borehole, a value of fluid holdup using the selected learning machine. For example, the selected learning machine, after validation, may be output to a real-world scenario to predict borehole holdup. Flow of the flowchart 600 may conclude after the operations of block 612.

### Example Well System

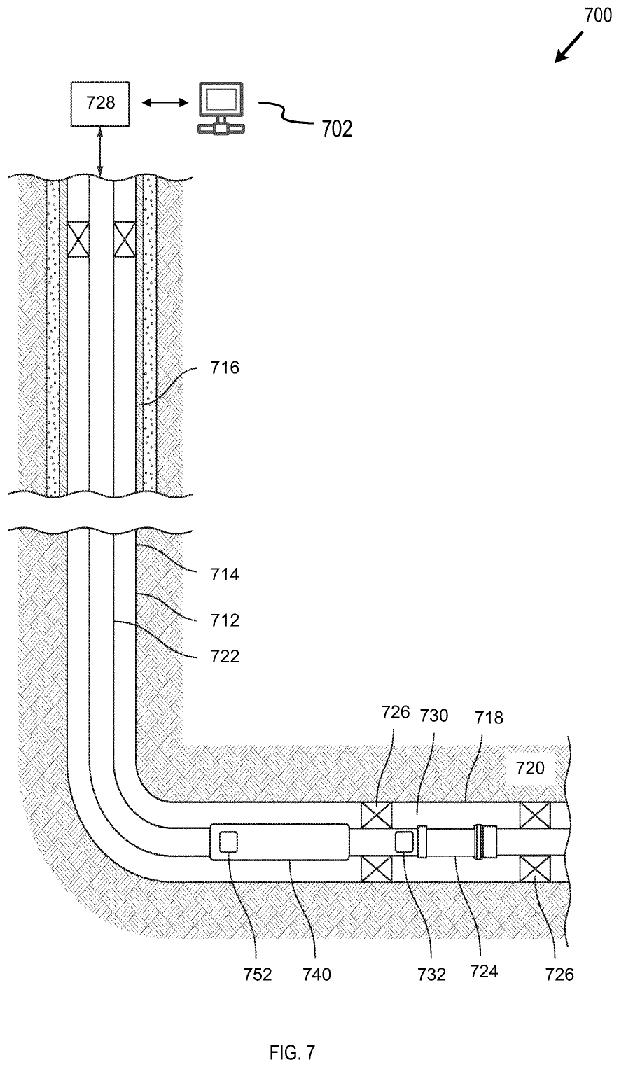

An example well system is now described. FIG. 7 is a cross-sectional diagram depicting an example well system, according to some implementations. The example well system of FIG. 7 may be described with reference to FIGS. 1-5. A well system 700 may comprise a wellbore 712 which intersects a subsurface formation 720. The wellbore 712 may include a vertical section 714 (which is at least partially cemented with a casing string 716) and a horizontal section 718. The horizontal section 718 may be an open-hole section of the wellbore 712. Other wellbore configurations may also be suitable.

Positioned within the wellbore 712 and extending from the surface is a tubing string 722 which provides a conduit for formation fluids to travel from the subsurface formation 720 to the surface and for stimulation fluids to travel from the surface to the subsurface formation 720. The tubing string 722 may include a production section 724 between one or more packers 726. The production section 724 may comprise multiple sections of pipe, including, for example, a sand screen section. The one or more packers 726 may provide a fluid seal between the tubing string 722 and the wellbore 712, thereby defining one or more production intervals 730. The production section 724 may comprise one or more valves 732 (e.g., interval control valves) configured to control fluid inflow and outflow to and from the production section 724. In some implementations, the tubing string 722 may comprise a power generation unit 740 to provide power to a telemetry unit 752. In other implementations, power may be conveyed downhole via a wired connection.

The well system 700 may further comprise surface equipment 728. The surface equipment 728 may comprise a wellhead, a choke, one or more production vessels (e.g., a three-phase separator, a low-pressure separator, etc.), and other production equipment. The surface equipment 728 may be coupled to a computer 702 which may be similar to the computer 502 of FIG. 5. The computer 702 may include a non-transitory computer-readable medium (e.g., a hard-disk drive and/or memory) capable of obtaining, storing, processing, and manipulating PNL sensor information obtained via a PNL tool used to log the wellbore 712. Additionally, the computer 702 may be capable of executing instructions to perform holdup predictions for fluids within the wellbore 712, such as the operations described by FIGS. 1-4. For example, a PNL tool may be used to log the wellbore 712. Based on obtained PNL sensor information, the computer 702 may be configured to output predictions of holdup for liquid, gas, etc. in the wellbore 712. Based on the holdup predictions, one or more operations may be conducted to alter a multi-phase fluid flow in the wellbore 712, if necessary. For example, the predictions of liquid (oil, water, or a combination of the two) and gas holdup may be indicative of a slug flow regime where gas and liquid may be received intermittently at the surface equipment 728. Sustained slug flow may cause damage to the surface equipment 728 such as damage to one or more separators. Based on holdup predictions output by the computer 702, operations such as adjusting an aperture of the choke, shutting in certain formations via the valve 732, and other measures may be performed to alter a multi-phase flow in the wellbore 712.

### Example Implementations

Implementation #1: A method for controlling a learning machine to predict fluid holdup in a borehole, the method comprising: generating an expanded dataset of simulated pulsed neutron logging (PNL) data based, at least in part, on an original dataset of empirical PNL data; converting, using one or more calibration coefficients, the simulated PNL data into lab-equivalent synthetic data; and training an ensemble of machine learning models based on the lab-equivalent synthetic data.

Implementation #2: The method of Implementation 1 further comprising: predicting, based on data collected from the borehole, a value of fluid holdup using a selected machine learning model.

Implementation #3: The method of any one of Implementations 1-2 further comprising: selecting a machine learning model of least error from the ensemble; and validating the selected machine learning model against the original dataset of empirical PNL data.

Implementation #4: The method of any one of Implementations 1-3 wherein generating the expanded dataset of the simulated PNL data comprises: calibrating, based on the empirical PNL data, one or more ratios and channels within the simulated PNL data, wherein the one or more channels comprise portions of a PNL spectrum.

Implementation #5: The method of Implementation 4, wherein converting, using the one or more calibration coefficients, the simulated PNL data into the lab-equivalent synthetic data comprises: plotting, for each channel of the one or more channels, the simulated PNL data against the empirical PNL data; generating a calibration curve to fit the simulated PNL data and the empirical PNL data; selecting a set of calibration coefficients based on a function of the calibration curve; and converting the simulated PNL data into the lab-equivalent synthetic data based on the set of calibration coefficients.

Implementation #6: The method of any one of Implementations 1-5, wherein converting, using the one or more calibration coefficients, the simulated PNL data into the lab-equivalent synthetic data further comprises: interpolating and extrapolating unknown data values to fill a variable space of the lab-equivalent synthetic data based, at least in part, on the one or more calibration coefficients.

Implementation #7: The method of any one of Implementations 4-6 further comprising: generating a set of features using a physics-based selection process, wherein the set of features maximizes a correlation between carbon, oxygen, and density measurements to a value of fluid holdup, wherein calibrating the one or more ratios and channels comprises mapping the set of features to the empirical PNL data.

Implementation #8: A holdup prediction system including a learning machine and comprising program code configured to predict fluid holdup in a borehole drilled into a subsurface formation, the program code executable on one or more processors, the program code comprising: instructions to generate an expanded dataset of simulated pulsed neutron logging (PNL) data based, at least in part, on an original dataset of empirical PNL data; instructions to convert, using one or more calibration coefficients, the simulated PNL data into lab-equivalent synthetic data; and instructions to train an ensemble of machine learning models based on the lab-equivalent synthetic data.

Implementation #9: The holdup prediction system of Implementation 8, further comprising: instructions to predict, based on data collected from the borehole, a value of fluid holdup in the borehole using a selected machine learning model.

Implementation #10: The holdup prediction system of any one of Implementations 8-9, further comprising: instructions to select a machine learning model of least error from the ensemble; and instructions to validate the selected machine learning model against the original dataset of empirical PNL data.

Implementation #11: The holdup prediction system of any one of Implementations 8-10, wherein the instructions to generate the expanded dataset of the simulated PNL data comprise: instructions to calibrate, based on the empirical PNL data, one or more ratios and channels within the simulated PNL data, wherein the one or more channels comprise portions of a PNL spectrum.

Implementation #12: The holdup prediction system of Implementation 11, wherein the instructions to convert, using the one or more calibration coefficients, the simulated PNL data into the lab-equivalent synthetic data comprise: instructions to plot, for each channel of the one or more channels, the simulated PNL data against the empirical PNL data; instructions to generate a calibration curve to fit the simulated PNL data and the empirical PNL data; instructions to select a set of calibration coefficients based on a function of the calibration curve; and instructions to convert the simulated PNL data into the lab-equivalent synthetic data based on the set of calibration coefficients.

Implementation #13: The holdup prediction system of any one of Implementations 8-12, wherein the instructions to convert, using the one or more calibration coefficients, the simulated PNL data into the lab-equivalent synthetic data further comprise: instructions to interpolate and extrapolate unknown data values to fill a variable space of the lab-equivalent synthetic data based, at least in part, on the one or more calibration coefficients.

Implementation #14: The holdup prediction system of any one of Implementations 11-13, further comprising: instructions to generate a set of features using a physics-based selection process, wherein the set of features maximizes a correlation between carbon, oxygen, and density measurements to a value of fluid holdup, wherein the instructions to calibrate the one or more ratios and channels comprise instructions to map the set of features to the empirical PNL data.

Implementation #15: One or more non-transitory machine-readable media including a learning machine and comprising program code configured to predict fluid holdup in a borehole drilled into a subsurface formation, the program code executable on one or more processors, the program code comprising: instructions to generate an expanded dataset of simulated pulsed neutron logging (PNL) data based, at least in part, on an original dataset of empirical PNL data; instructions to convert, using one or more calibration coefficients, the simulated PNL data into lab-equivalent synthetic data; and instructions to train an ensemble of machine learning models based on the lab-equivalent synthetic data.

Implementation #16: The machine-readable media of Implementation 15, further comprising: instructions to predict a value of fluid holdup in the borehole using a selected learning machine.

Implementation #17: The machine-readable media of any one of Implementations 15-16, further comprising: instructions to select a machine learning model of least error from the ensemble; and instructions to validate the selected machine learning model against the original dataset of empirical PNL data.

Implementation #18: The machine-readable media of any one of Implementations 15-17, wherein the instructions to generate the expanded dataset of the simulated PNL data comprise: instructions to calibrate, based on the empirical PNL data, one or more ratios and channels within the simulated PNL data, wherein the one or more channels comprise portions of a PNL spectrum.

Implementation #19: The machine-readable media of Implementation 18, wherein the instructions to convert, using the one or more calibration coefficients, the simulated PNL data into the lab-equivalent synthetic data comprise: instructions to plot, for each channel of the one or more channels, the simulated PNL data against the empirical PNL data; instructions to generate a calibration curve to fit the simulated PNL data and the empirical PNL data; instructions to select a set of calibration coefficients based on a function of the calibration curve; instructions to convert the simulated PNL data into the lab-equivalent synthetic data based on the set of calibration coefficients; and instructions to interpolate and extrapolate unknown data values to fill a variable space of the lab-equivalent synthetic data based, at least in part, on the set of calibration coefficients.

Implementation #20: The machine-readable media of any one of Implementations 18-19, further comprising: instructions to generate a set of features using a physics-based selection process, wherein the set of features maximizes a correlation between carbon, oxygen, and density measurements to a value of fluid holdup, wherein the instructions to calibrate the one or more ratios and channels comprise instructions to map the set of features to the empirical PNL data.

What is claimed is:

1. A method for controlling a learning machine to predict fluid holdup in a borehole, the method comprising:
generating an expanded dataset of simulated pulsed neutron logging (PNL) data based, at least in part, on an original dataset of empirical PNL data;
converting, using one or more calibration coefficients, the simulated PNL data into lab-equivalent synthetic data; and
training an ensemble of machine learning models based on the lab-equivalent synthetic data.

2. The method of claim 1 further comprising:
predicting, based on data collected from the borehole, a value of fluid holdup using a selected machine learning model.

3. The method of claim 1 further comprising:
selecting a machine learning model of least error from the ensemble; and
validating the selected machine learning model against the original dataset of empirical PNL data.

4. The method of claim 1 wherein generating the expanded dataset of the simulated PNL data comprises:
calibrating, based on the empirical PNL data, one or more ratios and channels within the simulated PNL data, wherein the one or more channels comprise portions of a PNL spectrum.

5. The method of claim 4, wherein converting, using the one or more calibration coefficients, the simulated PNL data into the lab-equivalent synthetic data comprises:
plotting, for each channel of the one or more channels, the simulated PNL data against the empirical PNL data;
generating a calibration curve to fit the simulated PNL data and the empirical PNL data;
selecting a set of calibration coefficients based on a function of the calibration curve; and
converting the simulated PNL data into the lab-equivalent synthetic data based on the set of calibration coefficients.

6. The method of claim 1, wherein converting, using the one or more calibration coefficients, the simulated PNL data into the lab-equivalent synthetic data further comprises:
interpolating and extrapolating unknown data values to fill a variable space of the lab-equivalent synthetic data based, at least in part, on the one or more calibration coefficients.

7. The method of claim 4 further comprising:
generating a set of features using a physics-based selection process, wherein the set of features maximizes a correlation between carbon, oxygen, and density measurements to a value of fluid holdup,
wherein calibrating the one or more ratios and channels comprises mapping the set of features to the empirical PNL data.

8. A holdup prediction system including a learning machine and comprising program code configured to predict fluid holdup in a borehole drilled into a subsurface formation, the program code executable on one or more processors, the program code comprising:
instructions to generate an expanded dataset of simulated pulsed neutron logging (PNL) data based, at least in part, on an original dataset of empirical PNL data;
instructions to convert, using one or more calibration coefficients, the simulated PNL data into lab-equivalent synthetic data; and
instructions to train an ensemble of machine learning models based on the lab-equivalent synthetic data.

9. The holdup prediction system of claim 8, further comprising:
instructions to predict, based on data collected from the borehole, a value of fluid holdup in the borehole using a selected machine learning model.

10. The holdup prediction system of claim 8, further comprising:
instructions to select a machine learning model of least error from the ensemble; and
instructions to validate the selected machine learning model against the original dataset of empirical PNL data.

11. The holdup prediction system of claim 8, wherein the instructions to generate the expanded dataset of the simulated PNL data comprise:
instructions to calibrate, based on the empirical PNL data, one or more ratios and channels within the simulated PNL data, wherein the one or more channels comprise portions of a PNL spectrum.

12. The holdup prediction system of claim 11, wherein the instructions to convert, using the one or more calibration coefficients, the simulated PNL data into the lab-equivalent synthetic data comprise:
instructions to plot, for each channel of the one or more channels, the simulated PNL data against the empirical PNL data;
instructions to generate a calibration curve to fit the simulated PNL data and the empirical PNL data;
instructions to select a set of calibration coefficients based on a function of the calibration curve; and
instructions to convert the simulated PNL data into the lab-equivalent synthetic data based on the set of calibration coefficients.

13. The holdup prediction system of claim 8, wherein the instructions to convert, using the one or more calibration coefficients, the simulated PNL data into the lab-equivalent synthetic data further comprise:
instructions to interpolate and extrapolate unknown data values to fill a variable space of the lab-equivalent synthetic data based, at least in part, on the one or more calibration coefficients.

14. The holdup prediction system of claim 11, further comprising:
instructions to generate a set of features using a physics-based selection process, wherein the set of features maximizes a correlation between carbon, oxygen, and density measurements to a value of fluid holdup,
wherein the instructions to calibrate the one or more ratios and channels comprise instructions to map the set of features to the empirical PNL data.

15. One or more non-transitory machine-readable media including a learning machine and comprising program code configured to predict fluid holdup in a borehole drilled into a subsurface formation, the program code executable on one or more processors, the program code comprising:
instructions to generate an expanded dataset of simulated pulsed neutron logging (PNL) data based, at least in part, on an original dataset of empirical PNL data;
instructions to convert, using one or more calibration coefficients, the simulated PNL data into lab-equivalent synthetic data; and
instructions to train an ensemble of machine learning models based on the lab-equivalent synthetic data.

16. The machine-readable media of claim 15, further comprising:
instructions to predict a value of fluid holdup in the borehole using a selected learning machine.

17. The machine-readable media of claim 15, further comprising:
instructions to select a machine learning model of least error from the ensemble; and
instructions to validate the selected machine learning model against the original dataset of empirical PNL data.

18. The machine-readable media of claim 15, wherein the instructions to generate the expanded dataset of the simulated PNL data comprise:
instructions to calibrate, based on the empirical PNL data, one or more ratios and channels within the simulated PNL data, wherein the one or more channels comprise portions of a PNL spectrum.

19. The machine-readable media of claim 18, wherein the instructions to convert, using the one or more calibration coefficients, the simulated PNL data into the lab-equivalent synthetic data comprise:
instructions to plot, for each channel of the one or more channels, the simulated PNL data against the empirical PNL data;
instructions to generate a calibration curve to fit the simulated PNL data and the empirical PNL data;
instructions to select a set of calibration coefficients based on a function of the calibration curve;
instructions to convert the simulated PNL data into the lab-equivalent synthetic data based on the set of calibration coefficients; and
instructions to interpolate and extrapolate unknown data values to fill a variable space of the lab-equivalent synthetic data based, at least in part, on the set of calibration coefficients.

20. The machine-readable media of claim 18, further comprising:
instructions to generate a set of features using a physics-based selection process, wherein the set of features maximizes a correlation between carbon, oxygen, and density measurements to a value of fluid holdup,
wherein the instructions to calibrate the one or more ratios and channels comprise instructions to map the set of features to the empirical PNL data.
